(19) United States
(12) Patent Application Publication
(10) Pub. No.: US 2015/0356122 A1
(43) Pub. Date: Dec. 10, 2015

(54) Data capture, storage, and retrieval software system.

(71) Applicant: SAMIR ISSA, RIYADH (SA)

(72) Inventor: SAMIR ISSA, RIYADH (SA)

(21) Appl. No.: 14/297,929

(22) Filed: Jun. 6, 2014

(51) Int. Cl. G06F 17/30

(52) U.S. Cl. CPC G06F 17/30294

(57) ABSTRACT

The current invention is a data capture, storage, and retrieval software system that is a Window's based system sitting on top of the operating system to handle data generated during business domain transactions. The current invention can be tailored to meet the business rules of certain domains by designing its templates on a customized basis.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND OF INVENTION

1. Field of the Invention

The present invention is a data capture, storage, and retrieval software system, In more particular a Window's based system sitting on top of the operating system to handle data generated during business domain transactions.

2. Background

In all business domains and transactions, the capture of data is done through electronic forms that customarily store data in tables. Usually the tables are designed either according to the process steps—procedural programming—or by mapping business transactions to software objects—object oriented programming—. In both cases, the resultant forms and tables are multiple creating visual sensory overload for the forms, and programming sophistication for the tables.

There is still room for improvement in the art.

### SUMMARY OF THE INVENTION

The current invention is a data capture, storage, and retrieval software system. It is a Window's based system sitting on top of the operating system to handle data generated during business domain transactions. Although the design of the current invention permits it to implement certain business rules of the domain, it does not implement all of those rules, its most versatile utilization is therefore in domains that require less of business rules implementation and more of data capture, storage, and retrieval. Notwithstanding the above, the current invention could be tailored to meet the business rules of certain domains by designing its templates on a customized basis.

The system has two programmatic objects called Mobject and Ditem.

In Ditem all the metadata about the piece of data that is represented by that Ditem (such as its data type, data qualifier, or any annotation/flagging related to the piece of data, etc). The most User-relevant attributes of the Ditem are the ‘Value’ and the ‘Label’. When the Ditem is persisted in the database, the ‘Value’ attribute is stored as a NVAR String regardless of its actual data type.

The Mobject has all the business domain context metadata in which the piece of data (Ditem) was generated. The Mobject holds also all the metadata that relates to the GUI in which the Mobject will be ultimately displayed to users as a web-form.

The Ditem represents a form control or a reports's field, the ‘Value’ of the Ditem represents the content of the web control and the ‘Label’ of the Ditem represents that control's label. The Mobject represents the form/report itself, and the Mobject's ‘Value’ is the Title of that form or web page.

There are three main applications that work together to make the current invention properly functional:

1. Template Builder TB application The XML output of TB is stored as XML/Mobject files in a special database called “ASPXTemplateDatabase”

2. Central Application CA: Consumes XML/Mobject files from the “ASPXTemplateDatabase” To generate web-forms that capture user input data; It also provides XML to the Submitter function of the Data Module, and displays Data Module returned XML files in response to queries; and

3. Data Module DM application: Consumes and provides XML feed to CA.

There are five XML-communicating software modules that are used/make part of the three above applications:

1. The Render Module RNDR: Used in CA and TB to transform XML Mobjects to ASPX pages;

2. The Submitter Module SBMTR: Parses XML Mobjects and writes the user input in the ASPX pages to the Production Database;

3. The Data Reader Module RDR: Executes Parametric queries on the Production Database to return results of user requests for data;

4. The Data Magic Reader DMR: Is a special module that operates within the DM to compile several filtered Mobjects to make of them a single table that combines them with their Ditems ‘Values’; and

5. The Selector Form SF: Is a service module that provides return values from data sources to be used by users as data input in the controls of web-forms.

There are three databases that store data related to the current invention:

1. TemplateBuilderDataBase: Used for the internal works of Template Builder application;

2. ASPXTemplateDatabase: Stores XML templates generated by Template Builder, exposes those template to Central Application web user, and return requested templates and

3. ProductionDatabase: Stores Mobjects and Ditems after having been updated by web user Production-data values.

### BRIEF DESCRIPTION OF THE DRAWINGS

Without restricting the full scope of this invention, the preferred form of this invention is illustrated in the following drawings:

FIG. 1 is a diagram of the data flow and dependency diagram;

FIG. 2 is a table of the Ditem states;

FIG. 3 is a table of Mobject states;

FIG. 4 is shows a Schema of the Production Database;

FIG. 5 shows a visual depiction of internal processing of Data Magic Reader Module Function;

FIG. 6 shows a Schema for the ASPX Template Database;

FIG. 7 displays the central application—Processing User Input Sequence Diagram;

FIG. 8 displays the central application—Processing User's Report-Request Sequence; and

FIG. 9 is a block diagram showing a basic arrangement of a computer system that can run the current invention.

### BRIEF DESCRIPTION OF THE PREFERRED EMBODIMENTS

There are a number of significant design features and improvements incorporated within the invention.

The current invention is a data capture, storage, and retrieval software system 1. In the preferred embodiment, it is a Window's based system sitting on top of the operating system to handle data generated during business domain transactions. Although the design of the current invention permits it to implement certain business rules of the domain, it does not implement all of those rules, its most versatile utilization is therefore in domains that require less of business rules implementation and more of data capture, storage, and retrieval. Notwithstanding the above, the current invention could be tailored to meet the business rules of certain domains by designing its templates on a customized basis. With the current invention, users are provided with the tools to design their own forms and reports as XML objects, and to use these XML objects to write and read data and information from the database.

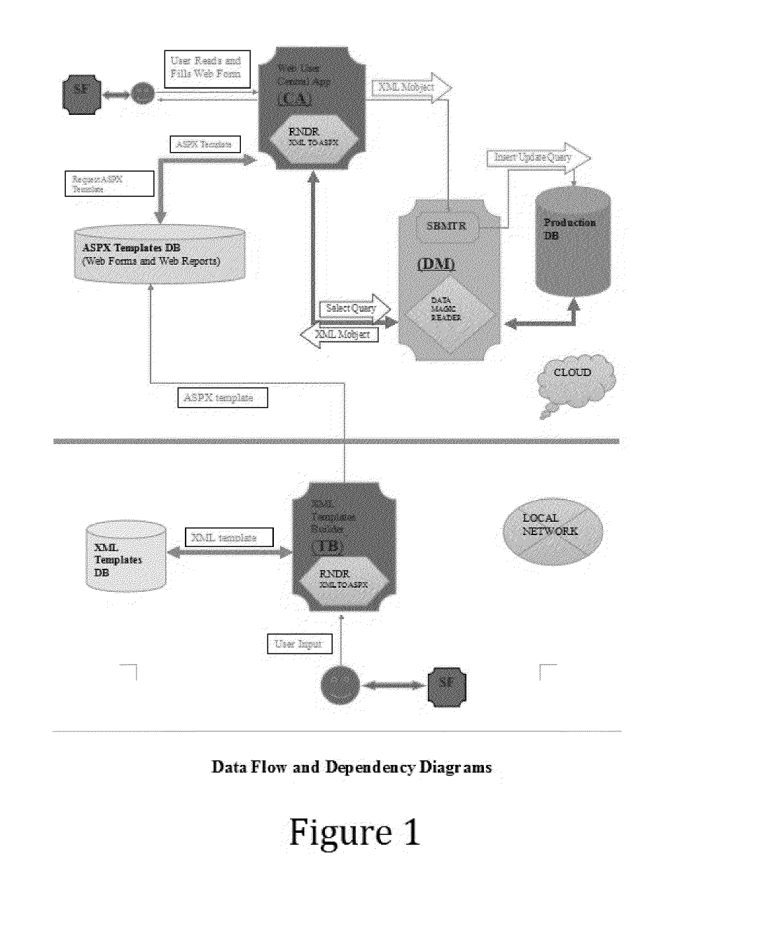

As shown in FIGS. 1 through 8, the current invention is a system 1, method and program.

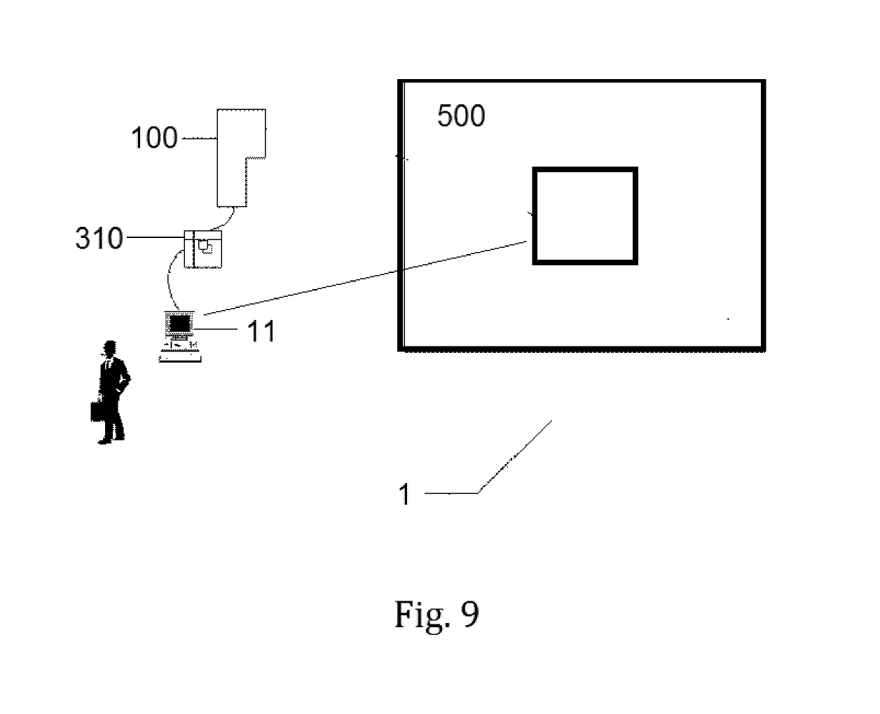

The storage and databases for the system may be implemented by a single data base structure database could be either of the relational type, or small amount of data, or non-relational of the key-value pair type for huge amounts of data. The database could be stored in an electronic readable form at an appropriate site, or by a distributed data base structure that is distributed across an intra or an Internet network as shown in FIG. 9.

The system 1 is a design of a process that simplifies user interface presentation and data storage in software applications.

The current invention software comprises two programmatic objects called Mobject and Ditem.

The system has two programmatic objects called Mobject and Ditem.

In Ditem all the metadata about the piece of data that is represented by that Ditem (such as its data type, data qualifier, or any annotation/flagging related to the piece of data, etc). The most User-relevant attributes of the Ditem are the ‘Value’ and the ‘Label’. When the Ditem is persisted in the database, the ‘Value’ attribute is stored as a NVAR String regardless of its actual data type.

The Mobject has all the business domain context metadata in which the piece of data (Ditem) was generated. The Mobject holds also all the metadata that relates to the GUI in which the Mobject will be ultimately displayed to users as a web-form.

The Ditem represents a form control or a reports's field, the ‘Value’ of the Ditem represents the content of the web control and the ‘Label’ of the Ditem represents that control's label. The Mobject represents the form/report itself, and the Mobject's ‘Value’ is the Title of that form or web page.

There are three main applications that work together to make the current invention properly functional:

1. Template Builder TB application The XML output of TB is stored as XML/Mobject files in a special database called “ASPXTemplateDatabase”

2. Central Application CA: Consumes XML/Mobject files from the “ASPXTemplateDatabase” To generate web-forms that capture user input data; It also provides XML to the Submitter function of the Data Module, and displays Data Module returned XML files it response to queries; and

3. Data Module DM application: Consumes and provides XML feed to CA.

There are five XML-communicating software modules that are used/make part of the three above applications:

1. The Render Module RNDR: Used in CA and TB to transform XML Mobjects to ASPX pages;

2. The Submitter Module SBMTR: Parses XML Mobjects and writes the user input in the ASPX pages to the Production Database;

3. The Data Reader Module RDR: Executes Parametric queries on the Production Database to return results of user requests for data;

4. The Data Magic Reader DMR: Is a special module that operates within the DM to compile several filtered Mobjects to make of them a single table that combines them with their Ditems ‘Values’; and

5. The Selector Form SF: Is a service module that provides return values from data sources to be used by users as data input in the controls of web-forms.

There are three databases that store data related to the current invention:

1. TemplateBuilderDataBase: Used for the internal works of Template Builder application;

2. ASPXTemplateDatabase: Stores XML templates generated by Template Builder, exposes those template to Central Application web user, and return requested templates and

3. ProductionDatabase: Stores Mobjects and Ditems after having been updated by web user Production-data values.

Life Cycle of the current invention Application Implementation:

1. Power user creates XML templates of Mobjects and Ditems using Template Builder Application.

2. XML templates are converted to ASPX pages and saved on ASPX template Database (By processing them through Render Module of Template Builder).

3. End user browse and retrieves an ASPX template that is processed and shown to him as a web form using Central Application Render Module.

4. End User enters input that updates the Mobject XML file (Render Module of Central Application) that is associated with a particular ASPX page template. After adding user input to the template, an instance Mobject full with user data is created.

5. End User saves the updated XML Mobject to the Production Database (Submitter function of the Data Module).

6. End User select a query/report (Central Application).

7. Central Application retrieves the query information and displays it to End User from the Production Database. (Reader Module of the Data Module).

A diagram of the data flow and dependency diagram of the current invention is shown in FIG. 1.

In any business domain of human transactions, different entities playing different roles perform different actions that generate transactional data elements. Those data elements are born themselves with a set of metadata (Such as the name of the data element, its value, and its data-type) themselves that identify them specifically. Data elements are also born within a context of domain activity that provides another set of specific metadata related to them.

The singular data element is called a Ditem ‘Value’, the Ditem being the set of metadata that strongly type this ‘Value’. The set of data representing the domain context in which the data element—i.e. The Ditem's ‘Value’—is born is called the Mobject, it represents another set of metadata further typing the Ditem. From a practical point of view, Ditem ‘Value’ is represented by the value entered by a user in a form's control, while the Mobject is represented in this analogy by the form that hosts this control.

In the following text the terms web-control control are used interchangeably with Ditem, as is web form and Mobject.

The Template Builder is an application that permits power users of a business domain to create XML templates representing the Mobjects and the Ditems.

Selector Form is a separate software module provided as part of the application. It services users of the application (Template Builder users, and end users of web forms) by returning a selection from a data source.

The Mobject and Ditem are programmatic objects that are represented, transported, and processed as XML objects. The set of attributes of both objects changes (some attributes are removed, some are added, and some are edited) as they are processed in the three main stages of their life cycle:

1. Stage at Template Builder application database (Birth Stage): This is the basic stage of the life cycle where all the basic attributes of the Mobject and Ditem are aggregated to create them.

2. Stage at ASPX templates database (Rich Stage): In this stage, the Mobject Becomes a ready-for-use template and adds to its attributes string representing the Mobject.

3. Stage at Production database (Lean Stage): The Mobjects and the Ditems are stripped of all the processing attributes. Only the attributes that are needed to filter the Mobject and Ditem in the Production Database, or to process their basic visual rendering are retained and persisted in the production database.

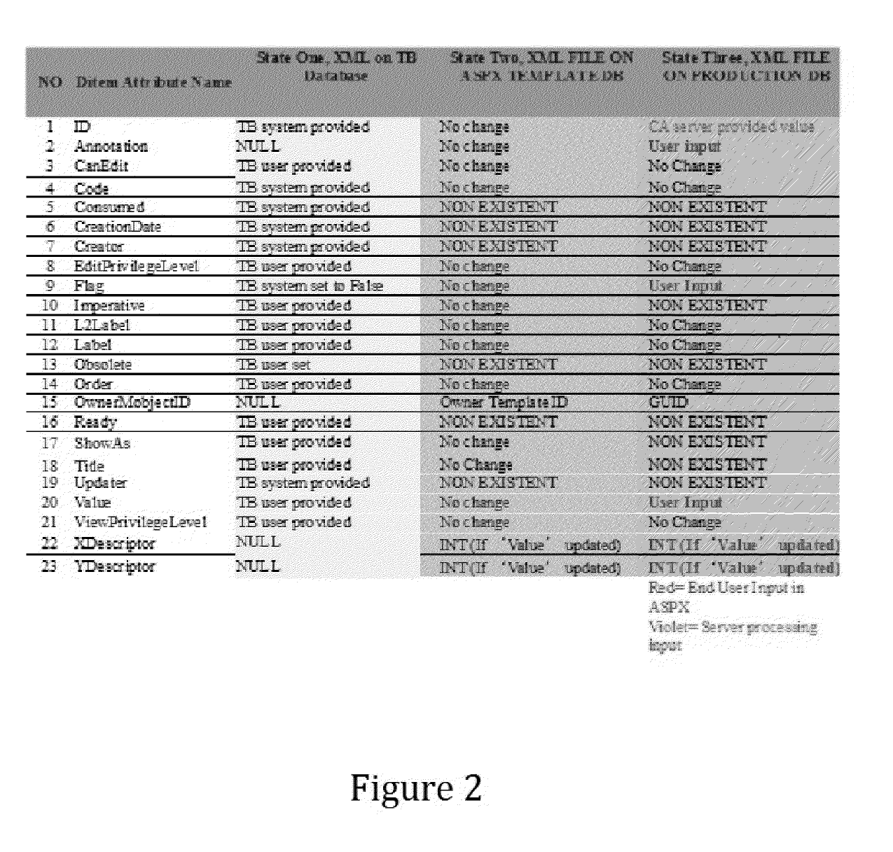

As shown in FIG. 2, the Ditems attributes can take one of three state s according to the location of the XML file that represents the Mobject holding the Ditems. In general, Ditem attributes get less and the Ditem gets ‘leaner’ as it progresses in its path towards the Production Database. Nevertheless some attributes—that are casted on the ‘Value’ attribute of the Ditem—are added to the XML file in order to strongly type and visually render the Ditem ‘Value’.

A Business Domain is any particular domain of human activity where users have similar data and information capture, storage, and retrieval needs.

A Power User is a Domain expert and Template Builder User who creates the Ditems and Mobjects.

An End User is the regular client end user who participates in domain transactions generating domain data that needs to be captured and processed by the application.

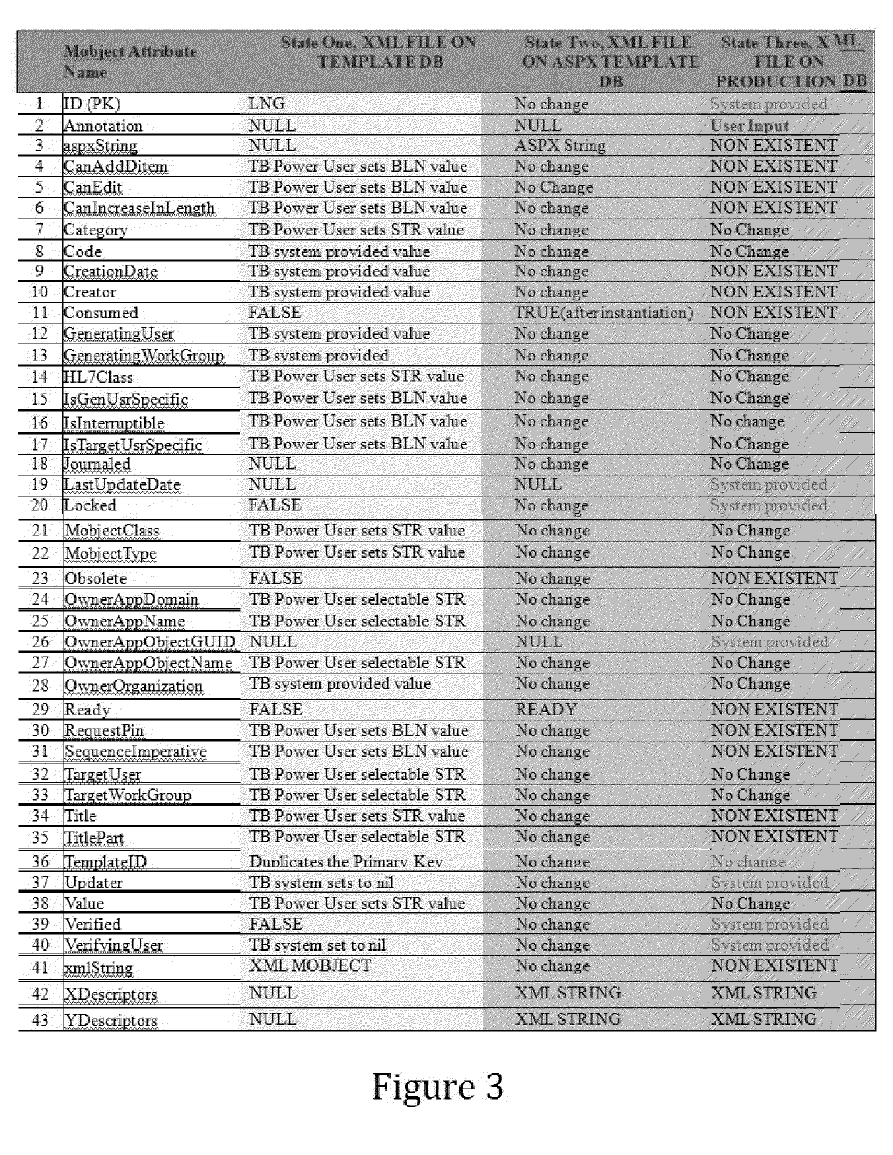

A Mobject State is the set and value of Mobject/Ditem attributes that the Mobject and its Ditems hold at a certain point of time. FIG. 3 displays Mobject states as explained below.

1. State One—Birth Stage—, XML Mobject created in Template Builder:

a) Created by Power User in Template Builder (a core XML object with its Ditems); and

b) Processed by Template Builder engine (adding an XML string attribute).

2. State Two—Ready Template Stage—, XML Mobject saved on ASPXTemplateDatabase:

a) Persisted in ASPX template database as a row containing all XML Mobject attributes including the XML string;

b) XML Mobject retrieved by Central Application web server and processed through the Central Application Render Module to produce a web-form;

c) ASPX page i.e. web-form displayed in a client station to the End User for his input; and

d) End User inputs values in the ASPX page controls, the values are validated against embedded business rules.

3. State Three—Saved Instance Stage—XML Mobject instance saved on Production Database: When the End User submits a data-updated ASPX page for saving, Central Application does three things:

a) Strongly types the Mobject instance updating its XML file with runtime system provided values such as ‘OwnerAppName’, ‘OwnerAppObjectName’, and ‘OwnerAppObjectGUID’ if these values were not provided previously in the XML template;

b) Updates the Mobject's Ditems ‘Values’ with End User input entered in ASPX page controls, and updates the XML file of the Mobject with values of any other gained attributes such as ‘Annotation’, ‘Flag’, and the X and Y descriptors in case of Comparison or Invoice type of Mobjects; and

c) Sends the updated XML file of the Mobject and its Ditems to be processed by the Data Module and saves them in the Production database.

The current invention has a Render Module (RNDR) XML to ASPX. The Render Module has two duties:

1. Consumes XML file of a Mobject(s) and its associated Ditems to generate an ASPX file capable of generating a web form aware of all the attributes and events of the Mobject(s) and Ditems; and

2. Receives user input in the generated ASPX page, and updates the XML file behind the page.

The Render module is incorporated in the built of the Template Builder, and it also makes part of the Central Application. In the former, Template Builder consumes the generated ASPX to show the Power User a preview of the resultant web form with a ‘Save’ Button. In the latter, it consumes a retrieved ASPX template and uses the ASPX string to display a web form that is used to capture end user input. In this case the web form displays a ‘Submit’ button, when pressed by the end user it sends the user input updated XML file to the Data Module for persisting it.

The Render module itself does not have a visible user interface because it performs its functions under the cover of the application running it to generate a user interface as a web form in these applications.

The Data Flow and Functions of the Render Module as set out below:

Inputs:

An XML Mobject of any of the following types:

1. Simple stack form: Simple Vertical Collection;

2. Simple one textbox Array;

3. Multiple horizontally-replicated stack: Comparison-columns type of web form;

4. Multiple vertically-replicated stack: Invoice type of web form;

5. Multiple horizontally/vertically aligned different Arrays. MHA/MVA; and

6. Composite web form: consists of a container web form that has several tabs on each of which sits one of the above five forms.

User input in web pages generated by the module.

Outputs:

ASPX or HTML string that could be displayed as web page that has a Save′, ‘Save As’, or ‘Submit’ button. When this ‘Save’ or ‘Save As’ button is pressed, the generating XML, is saved, as a string attribute of the generating XML Mobject in the XMLTemplates Database.

In Central Application Render Module, the user-input-updated XML mobject is saved to the Production Database where it is submitted for insertion/update through the SBMTR function of Data Module.

The Functions of the Render Module:

1. Receives an XML file, parses it, and processes the information to generate a ASPX/ASP.net page, i.e. ASPX file.

a) According to the type of Mobject received and processed, the resulting ASPX shall generate a web page corresponding to the Mobject type.

b) Two types of ASPX pages could be generated:

One, the RNDR component of Template Builder shall have a ‘Save’ and a ‘Save As’ Buttons on its generated web-form. The ‘Save’ button shall save the Mobject in the ASPXTemplateDatabase under its current attributes along with its representation in n XML string. The ‘Save As’ button does the same but under a new ‘Title’, and ‘Value’ attributes of the Mobject. The user is prompted to enter the new string of the ‘Title’ attribute.

Two, the RNDR component of Central Application shall have a ‘Submit’ button on the displayed web page instead of the ‘Save’ button. Pressing this ‘Submit’ button will send the user-input-updated Mobject XML string to the SBMTR module of Data Module.

c) The Central Application type with a ‘Submit’ button shall have a right-click menu “Annotate Form’ for the page itself that permits annotation to be added to the web page.

d) Both types should permit the user to add new Ditem collections to their Comparison and Invoice Mobjects by having an ‘Add Column’ or ‘Add Row’ button respectively.

e) In both types of web pages with their Mobject of the Array type or simple collection type, the user can add new Ditems that are replica of the array base, or of the ‘User Defined Data’ type in simple collection type of Mobjects. For this, the web page must display an ‘Add Control’ Button.

f) Both types of web pages should also display a right-click menu related to any control on the web page. The right-click menu related to the controls displays three items: Annotate, Flag, and Negate. A User can add an annotation to any control, i.e. Ditem, by right-clicking an annotation button, this results in opening a very simple annotation form that captures the user input string and assigns it to the Ditem's ‘Annotation’ attribute value. A User can flag a control by clicking a right menu item called Flag. Once clicked, the control image in the XML file adds a ‘Flag’ attribute and sets it to True. If the menu item is clicked again when its already flagged, this reverses the steps, and the ‘Flag’ attributes is deleted from the XML file. A User can negate a textbox content by clicking a right click menu item. In this case, the string in the control label is concatenated with a ‘No’ in its left end and assigned as a value to the control text box.

Example: if Label=“Fever”, then if the control is negated, the textbox string shall become=“No Fever”.

2. Updates the XML file of the Mobject with any changes that affect the web controls on the web form. These changes are of four types that correspond to the three menu-items of the right-click button, and changes of the control's ‘Value’ by user input actions.

3. Updates the XML file behind the web page with any change in the structure of the web page that results from adding new controls i.e. Ditems, or new Ditem collections i.e. Columns (Comparison Type) or Rows (Invoice Type). In order to permit the user to add columns or rows, the web page must display to the user an ‘Add Column’ or ‘Add Row’ Button. The Mobject can keep increasing in length until the count of collections becomes equal to the value of ‘CanIncreaseInLength’.

4. Receives an XML file, parses it, removes XML markings, and generate a human-friendly HTML web page that is returned as a read-only HTML file.

Rules Controlling Generation of Webforms from XML Mobjects:

1-Producing a Simple Stack Form Using the SVC.xml File
The form name shall be equal to the mobject ‘Value’ attribute.
Ditems are stacked vertically (Simple Vertical Collection): In this case, labels are stacked on the left side, and their corresponding controls are stacked on the right side, each control aligns with its Ditem label. The collection of Ditems can be increased only by adding a one or more Ditem whose ‘Title’=‘UserAddedData’ and whose code attribute=“usrddddt”. The Ditem control in case of user added data is of the multiline text box type.
There shall be a ‘Save’ and a ‘Save As’, or a ‘Submit’ buttons only,
The Mobject gains the XML string as a new attribute.
The Mobject is saved with all of its attributes to the ASPX Template Database or sent as XML updated Mobject.

2-Producing a Simple One Textbox Form Using the SVA.xml File
The form name shall be equal to the mobject ‘Value’ attribute.
The simple Ditem is stacked vertically with its label on top of the control (Simple Vertical Array): In this case, The user can add new controls and the base Ditem can be increased by adding another Ditem represented on the form by a new control replicating the existing one, no new label is added in this case because the two controls share the same label.
The user cannot replicate the base array itself to create a second column.
There shall be a ‘Save’ and a ‘Save As’, or a ‘Submit’ buttons only,
The Mobject gains the XML string as a new attribute.
The Mobject is saved with all of its attributes to the ASPX Template Database or sent as XML updated Mobject.

3-Producing a Comparison Type of Form Using the Comparison.Xml File
The form name shall be equal to the mobject ‘Value’ attribute.
This type is the same as in SVC in which the minimum number of vertical collections is one (which differs from SVC only in its ability to increase in length as a mobject).
The ability of the user to add a ‘user added data’ Ditem is not implemented.
The user cannot increase the length of any collection
Depending on the mobject attribute ‘CanIncreaseInLength’, the user can replicate the base collections and add new vertical collection that will be aligned to the right beside the last existing collection creating new comparison column. If he does so, he should be prompted to provide the ‘DitemCollectionDescriptor’ of the newly added collection. The newly added ‘DitemCollectionDescriptor’ of the new collection should be of the same data type of the first collection.
There shall be a ‘Save’ and a ‘Save As’, or a ‘Submit’ buttons only,
The Mobject gains the XML string as a new attribute.
The Mobject is saved with all of its attributes to the ASPX Template Database or sent as XML updated Mobject.
When the user interacts with the Comparison web page controls and enters any data in any cell or changes the ‘Annotation’, ‘Flag’, or ‘Negate’ menu items, the XML file should be updated. Updating the XML file affects the Ditem behind the control—which is actually a cell in a table layout now—by updating its XDescriptor (Column Number) and YDescriptor (Row Number), and also updating any changed Ditem attribute. In other words, the Ditem data (including X and Y descriptors) do not exist in the XML file for any cell in the table unless this cell has been affected by a user action.

4-Producing a Invoice Type of Form Using the Invoice.Xml File
The form name shall be equal to the mobject ‘Value’ attribute.
In this type the Ditems of the Simple Collection are stacked/aligned horizontally instead of vertically as in Simple Vertical Collection type.
The minimum number of horizontal collections is one (This type of Mobject adds new collections by stacking new collections under the base one). In this case, the labels of Ditems act like column heads to the controls below them.
The ability of the user to add a ‘user added data’ Ditem is not implemented.
The user cannot increase the length of any collection
Depending on the mobject attribute ‘CanIncreaseInLength’, the user can replicate the base collections and add new horizontal collection that will be placed below the last existing collection.
‘DitemCollectionDescriptor’ of the newly added collection is automatically added and the user is not prompted to add it. The newly added ‘DitemCollectionDescriptor’ should be an integer representing row order in the invoice type form.
There shall be a ‘Save’ and a ‘Save As’, or a ‘Submit’ buttons only,
The Mobject gains the XML string as a new attribute.
The Mobject is saved with all of its attributes to the ASPX Template Database or sent as XML updated Mobject.
When the user interacts with the Invoice web page controls and enters any data in any cell or changes the ‘Annotation’, ‘Flag’, or ‘Negate’ menu items, the XML file should be updated. Updating the XML file affects the Ditem behind the control—which is actually a cell in a table layout now—by updating its XDescriptor (Column Number) and YDescriptor (Row Number), and also updating any changed Ditem attribute. In other words, the Ditem data (including X and Y descriptors) do not exist in the XML file for any cell in the table unless this cell has been affected by a user action.

5-Producing a Non-Comparison Type of Form Using the MHA.xml File
The form name shall be equal to the mobject ‘Value’ attribute.
This type consists of a fixed number of simple arrays aligned horizontally one beside the other. Each one of these arrays consists of a Ditem that has a label and a control. The control is placed beneath the label, and the arrays are aligned next to each other.
The ability of the user can not add a user-added-data Ditem.
The user can increase each array individually by replicating its Ditem. The added new ditems result in adding replicas of the base control stacked under the same label.
The Mobject can not increase in length.
There shall be a ‘Save’ and a ‘Save As’, or a ‘Submit’ buttons only,
The Mobject gains the XML string as a new attribute.
The Mobject is saved with all of its attributes to the ASPX Template Database or sent as XML updated Mobject.

6-Producing a Composite Type of Form that Holds Simple Forms Each on a Separate Tab:
The form name shall be equal to the mobject ‘Value’ attribute.
Visually, the composite Mobject displays a tabbed web page with one of any type of simple Mobject on each tab. Composite Mobjects can not have on their tabs other Composite Mobjects.
Composite Mobject has all the normal attributes of a regular Mobject, and in addition it has several member Mobjects in the ‘MobjectMemberGroup’ XML element.
The number of tabs on the composite form is equal to the number of members in the ‘MobjectMemeberGroup’.
Within the ‘MobjectMemberGroup’ the members are ordered as per the ‘Order’ attribute in the membership attributes.
Navigating from one tab to the other is governed by the ‘SequenceImperative’ attribute.
There shall be a ‘Save’ and a ‘Save As’, or a ‘Submit’ buttons only
The Mobject gains the XML string as a new attribute.
The Mobject is saved with all of its attributes to the ASPX Template Database or sent as XML updated Mobject for further submission. In the XML file that is saved in the Template Database or ASPX Template Database, the member Mobjects XML files do not need to be saved as an entire string with the XML string of the parent composite Mobject, a simple reference to the templatelD in the Template database should be sufficient to retrieve and process the corresponding XML file once its tab is clicked.

Template Builder Application

The Template Builder Application (TB) is a Window's based software module that permits power users of a certain domain to create XML files representing Mobjects (web forms) and Ditems (web controls) related to business transactions in the said-domain. Template Builder is therefore specific for a particular business domain because it generates specifically typed Mobjects and Ditems for that particular domain.

Example: Mobjects generated in a Template Builder geared for Electronic Medical Record, have attributes that are specific to the business rules of EMR and medical practice.

Nevertheless, the theoretical principle remains valid for any domain and it requires only the assignment of a special set of attributes to validate the Template Builder for a different business domain.

For using the application in a business domain, the following steps are followed:

1. Define the applications that will use Production Database for storing their forms' information.

2. Define all the work groups that will use each application.

3. Each defined work group must:

a) Provide a list of all the forms (used to capture data), and reports (used to output data) that it needs in its functions.

b) Define all the business processes that depend on these forms and the sequence of processing of the forms.

4. The lists are compiled to generate a list of all the Ditems i.e. Controls that will be used to build the forms.

5. The Ditems are created in Template Builder and stored in Template Builder Database.

6. Simple Mobjects are created using pre defined Ditems to reflect the list of forms: Users creating the Mobjects are in reality creating XML templates of each web forms.

7. Composite Mobjects are created to reflect Composite data entry forms, and business processes and protocols.

8. The pool of Mobjects and Ditems is dynamic and new Mobjects could be created ad hoc as need arises.

The Template Builder permits the creation of three basic types of Mobjects depending on the source of data in their Ditems.

1. Input Mobjects: The controls in this Mobject receive their input from end user interaction.

2. Output Mobjects: The controls in this Mobject receive their input from querying the Production Database.

3. Query Mobjects: These XML Mobjects contain all the information and parameters needed to create and execute a query against the Production Database.

When the user creates a Mobject (web business form/report/Query), he is prompted in a wizard-like Template Builder user interface to assign values to all the attributes of that mobject, thus providing all the metadata and context of the Mobject. Normally, the attributes of the Mobject are specific to the particular business domain and therefore contribute in applying certain business rules of that domain. The business domain related attributes of a Mobject are in inverse relation to amount of processing/server interaction that will be required at the user's end of that Mobject. Afterwards, the user is prompted in the same way to add to this mobject (web form template) all the Ditems (controls) that are selected from the existing pool.

Input to the Template Builder:

Power User creates and enters all the values of attributes of Input Mobjects and Ditems.

Power User creates templates of queries that will populate an Output Report Mobject.

Power User creates and enters all the values needed to create a query on the Production Database.

Internal Processing of Template Builder:

Transforms Power User input to XML templates of Mobjects and Ditems. To perform its functions Template Builder stores its processing data in the TemplateBuilderDatabase.

Transforms Power User input to a list of query attributes processed later by the Central Application to build reports/queries processed by the Data Module.

Output from Template Builder:

ASPX templates of Input Mobjects and Templates for queries of Output Mobjects are stored in the ASPXTemplateDatabase accessible by the Central Application server.

Types of XML elements created by TB

1-Web control (Ditem):

A script in the final ASPX page shall validate user input to match the specified data type and eventually any encoded business rule in the Ditem's XML.

1. Simple text box (String)

2. Multiline text box (String)

3. Numeric text box (Integer, Float):

4. Checkbox (Boolean):

5. Combobox (Selectable): Has a feeder string that provides the contents of the drop box, could also be shown as a set of Radio Buttons.

Example of a Ditem XML file

<DitemTemplate z:Id=“i3” i:type=“SingleLineStringDitemTemplate”>
<EntityKey z:Id=“i4”>
<d4p1:EntityContainerName>TemplateEntitiesContainer
</d4p1:EntityContainerName>
<d4p1:EntityKeyValues>
<d4p1:EntityKeyMember>
<d4p1:Key>Id</d4p1:Key>
<d4p1:Value i:type=“d7p1:int”>10</d4p1:Value>
</d4p1:EntityKeyMember>
</d4p1:EntityKeyValues>
<d4p1:EntitySetName>DitemTemplates</d4p1:EntitySetName>
</EntityKey>
<Code>prsnfrstnm</Code>
<Consumed>false</Consumed>
<DefaultValue>Mhmd</DefaultValue>
<DitemType>Single Line String</DitemType>
<EditPrivilegeLevel>0</EditPrivilegeLevel>
<Id>10</Id>
<Imperative>false</Imperative>
<L2Label>Person First Name</L2Label>
<Label>Person First Name</Label>
<Obsolete>false</Obsolete>
<Order>0</Order>
<QueryID i:nil=“true”/>
<ShowAs i:nil=“true”/>
<Title>Person First Name</Title>
<ViewPrivilegeLevel>0</ViewPrivilegeLevel>
<NullText>Enter First Name</NullText>
<WithNigationIndicator>false</WithNigationIndicator>
</DitemTemplate>

2-Simple Input Web Form (Simple Mobject):

Used to collect user input when entered in web controls.

1. Simple stack (different Ditems) or arrays (replicated Ditem) form: Usual type of web forms for data entry.

2. Comparison type of columnar form: Can be used to compare several columns, or serially follow a changing value(s). The user can increase the column number if permitted by the form creator up to a pre-determined number, and in this case has to provide the newly added column name.

3. Invoice type of web form: Can be used to add lines of a set of Ditems as in an invoice.

4. Multiple different stacks or multiple different arrays on one form.

5. Pixel type of web form: where the Ditems i.e. Web controls are related to an image with particular labels on that image representing the Ditem's label.

3-Simple Output Web Reports:

These are XML Mobjects that hold one or more of the following elements that was entered by the report creator:

The codes/names of certain Mobjects (web forms); and

The codes/names of certain Ditems (web controls).

The XML object also holds the time/date span criterion that is used to filter for any of the above elements. This XML file is passed on to the RDR module that parses it and brings, as a return value, the specified elements in XML format. The elements are then stripped from the XML formatting and displayed as friendly text to the user.

4—Multi-Tabbed Composite Form:

This type of form holds on each of its tabs one of the above input or output forms. It can be used to represent a sequential business process/protocol.

The Data Module Application (DM)

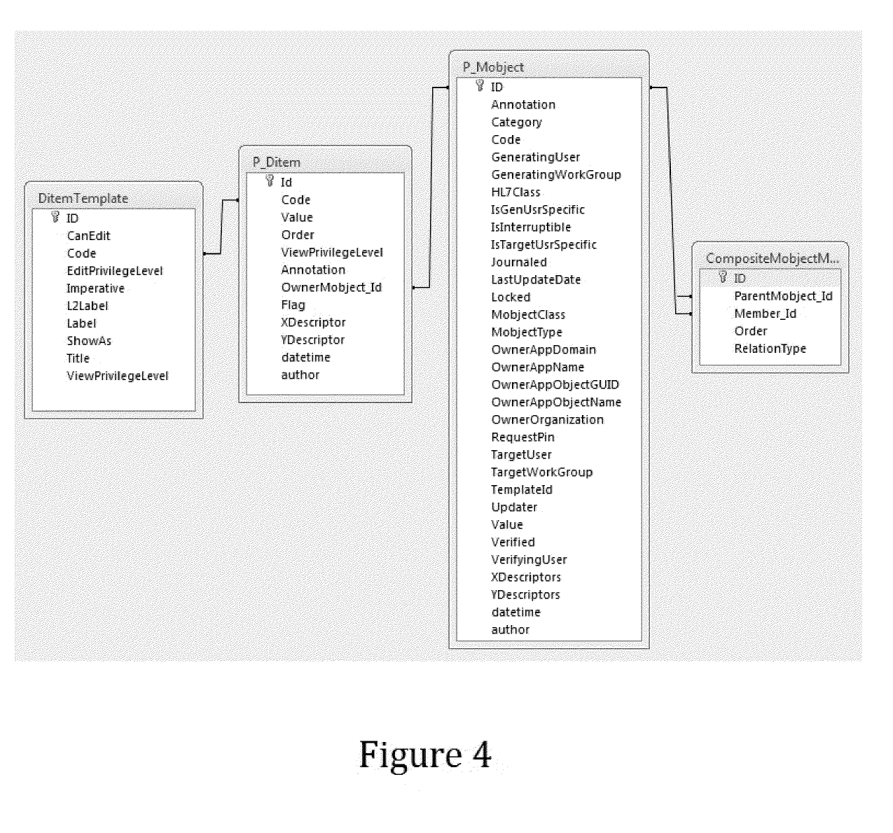

The Data Module Application is an interface that writes to and reads from a database called Production Database, These functions are executed through two software modules (SBMTR, RDR) each of interacts with the Production Database through its own functions. FIG. 4 shows a Schema of the Production Database.

The Production Database can host the data of several applications inside. Each serviced application has its Mobjects typed with its code/name. The Data Magic Reader module helps to render a classic table view of traditional relational databases to any requesting module. Each Mobject in the Production Database is also typed with its programmatic name in the owner application, and a unique id (GUID) related to that application. In this Production Database, Ditem's ‘Value’ attribute data type is of the (NVAR) type.

The SBMTR Module

The Submitter (SBMTR Module) has a writer Function that receives an XML file, parses it, and accordingly executes an insert/update query on the Production Database.

Input:

The Submitter Module receives an XML string message containing the following parameters that should be extracted after parsing the XML string:

1. A Data Key Service to permit access to the Production Database.

2. Number of operations requested.

3. Set of Operations requested where each one has the following parameters:

a) Type: [Insert, Update]

b) Update filter primary key parameter: Imperative and takes only a GUID key as argument

c) XML string representing a simple/composite Mobject, A Ditem, A Mobject with its Ditems, A Mobject set with their Ditems.

Example SBMTR message XML:

<SBMTRMESSAGE>
<DataServiceKey/>
<NumberOfOperationsRequested/>
<Operations>
<Operation>
<OperationType/>
<Target/>
<UpdatePK/>
<MobjectXMLString/>
</Operation>
</Operations>
</SBMTRMESSAGE>

Output:

The SBMTR module returns to the Central Application either:

1) If Error Code=0, returns “Requested Operation Performed” for a successful insertion/update operation.

2) Error code and error message as string with rollback on all transactions requested in the XML message.

Internal Processing of SBMTR Module:

When the SBMTR module receives the XML string, it parses it to extract the elements of the XML input file. After parsing the XML of each requested operation, the SBMTR shall build an SQL statement to perform the requested task. After building the set of required SQL, the SBMTR establishes connection with the Production Database using the Data Service Key information and executes the statements.

Rules to Follow when Inserting Data in Production Database:

If Error Code results from a violation of Primary Key Insert operation on table′DitemTemplate′, the error be ignored and the ‘INSERT’ statement should be dropped.

The SBMTR function shall have the following internal functions that are called to execute any incoming requests of insert or update:
InsertDitem: Takes an XML Ditem string.
InsertCompositMembers; Takes an XML CompositeMembersString.
InsertSimpleMobject: Takes a Simple Mobject XML string and will use the ‘InsertDitem’ function internally.
InsertCompositeMobject: Takes a Composite Mobject XML string and will use the ‘InsertDitem’, ‘InsertCompositeMembers’, and ‘InsertSimpleMobject’ functions internally.
UpdateDitem:
UpdateSimpleMobject: Will use ‘UpdateDitem’ or ‘InsertDitem’ internally.
UpdateCompositeMobject: Will use the ‘UpdateDitem’, and ‘UpdateSimpleMobject’ functions internally.

The RDR Module

The RDR module is the module that accesses the Production Database to return data, in XML messages, as information to users of the Central Application.

The ParametericQueryReader Function:

Input of ParametericQueryReader Function: XML strings providing parameters for queries that should be executed against the Production Database. The XML is parsed, the corresponding query SQL is built and executed.

Regardless of which function is called in the RDR module, several parameters must be supplied:

1. A Data Service Key: The Data Service Key should provide all the information necessary to access the Production Database and query it.

2. The Target table: If no default specified, it includes a joint on Mobject/Ditem/CompositeMobjectMembers tables, otherwise message should specify which tables (Mobject/Ditem/CompositeMobjectMembers) are to be queried:

3. The column(s) of the target table to be returned.

4. Query Return Type: The module return-result must correspond to one of the return queries types specified in the request parameters.
Return Types of queries:s
1. Single Composite Mobject with its member Mobjects using Mobject PK. The Ditems of each member Mobjects are also returned.
Example: Returns all the simple Mobjects [CBC order Form, Blood Sample Withdrawal Form, CBC Result Report] related to the Composite Mobject CBC Process, retrieves the CBC process Template using the Template ID returned.
2. Single simple Mobject with its Ditems using Mobject PK. The returned Mobject could be any of Simple Vertical/Horizontal Collection, Comparison, Invoice, multi Horizontal/Vertical Array. The template ID of the returned Mobject is used to retrieve the template that is necessary for creating the proper display type.Single Composite Mobject with its member Mobjects using Mobject PK. The Ditems of each member Mobjects are also returned.
Example: Returns simple Mobject [CBC order Form] as a simple text because the Mobject is a simple vertical collection. If the Mobject was of Invoice, Comparison, or Multi-array type then the TemplatelD value will be used to retrieve the corresponding template and display the Mobject properly using a copy of RNDR module in CA.
3. Set of Mobjects filtered using [OwnerAppObjectGUID] and other parameters including a date delimiter one. The Mobjects are displayed as a list that could be expanded when any particular Mobject is selected to show its Ditems.
4. Set of Ditems filtered through provided parameters
5. A set of ‘Distinct’ Mobjects filtered using [OwnerAppObjectGUID] using the same template ID/Code, and a date delimiter
6. A List of Mobjects sharing the same ‘Distinct’ Mobject template ID.

6. Filter(s): The Filter(s) is one or more strings that determines the column name in the target table and the string/values to filter for. Several strings could be used to perform the query. Most frequently a date/time filter is used along with ID filters if applicable.

7. Date delimiter value: To be added to the set of provided filters in order to limit the filter process to a certain time interval as of the current date.

Example Parametric Query Request XML:

<ParametricQueryRequestMessage>
<DataServiceKey/>
<TargetTable/>
<ReturnedColumns>
<ColumnName/>
</ReturnedColumns>
<QueryReturnType/>
<Filters>
<Filter DataType=“” FilterString=“”/>
</Filters>
<DateDelimiter/>
</ParametricQueryRequestMessage>

Output of ParametericQueryReader Function:

a) ADO Data Set (Mobject/Ditem/CompositeMembers tables)

b) ADO Data Table (Mobject or Ditem Data Table)

c) XML file representing a report, a Data Set, or a Data Table

ReportReader Function:

Input ReportReader Function: Receives requests of XML web report (output) Mobjects from Central Application, parses them, execute the requested Select Queries on the Production Database.

Example Output Report Request XML:

<OutputReportRequestMessage>
<OwnerAppName/>
<OwnerAppObjectGUID/>
<OwnerAppObjectName/>
<SectionHeads>
<SectionHead>
<Ditems>
<Ditem Label=“” Code=“” DateDelimiter=“”/>
</Ditems>
<Mobjects>
<Mobject Title=“” Code=“” DateDelimiter=“”/>
</Mobjects>
</SectionHead>
</SectionHeads>
</OutputReportRequestMessage>

Returns ReportReader Function:

XML file containing the set of Mobject/Ditem collection(s) that correspond to the requested Output Mobject report formatting.

Data Magic Reader Function:

This is a module that makes part of the Data Module Application, it has a specific function to receive an XML file of set of Mobjects with their corresponding Ditem and it then transforms them into one table. The newly formed table is serialized to XML and sent as output of the function.

Input MagicReader Function:

Data Set composed of two Data Tables: Table one is a set of Mobjects, and Table 2 is the set of Ditems related to the set of Mobjects in Table 1 through a joint using the Mobject PK in Ditem.

Example MagicReader Request XML:

<MagicReaderRequestMessage>
<MobjectCode/>
<Filters>
<Filter DataType=“” FilterString=“”/>
</Filters>
</MagicReaderRequestMessage>

Output MagicReader Function:

One Data Table representing all the requested Mobjects along with their Ditems Values. Each Mobject represents a row filled in first column with Mobject's ‘Value’ attribute, and the rest of the columns each of which contains a Ditem's ‘Value’ attribute whose column head is the Ditem Label.

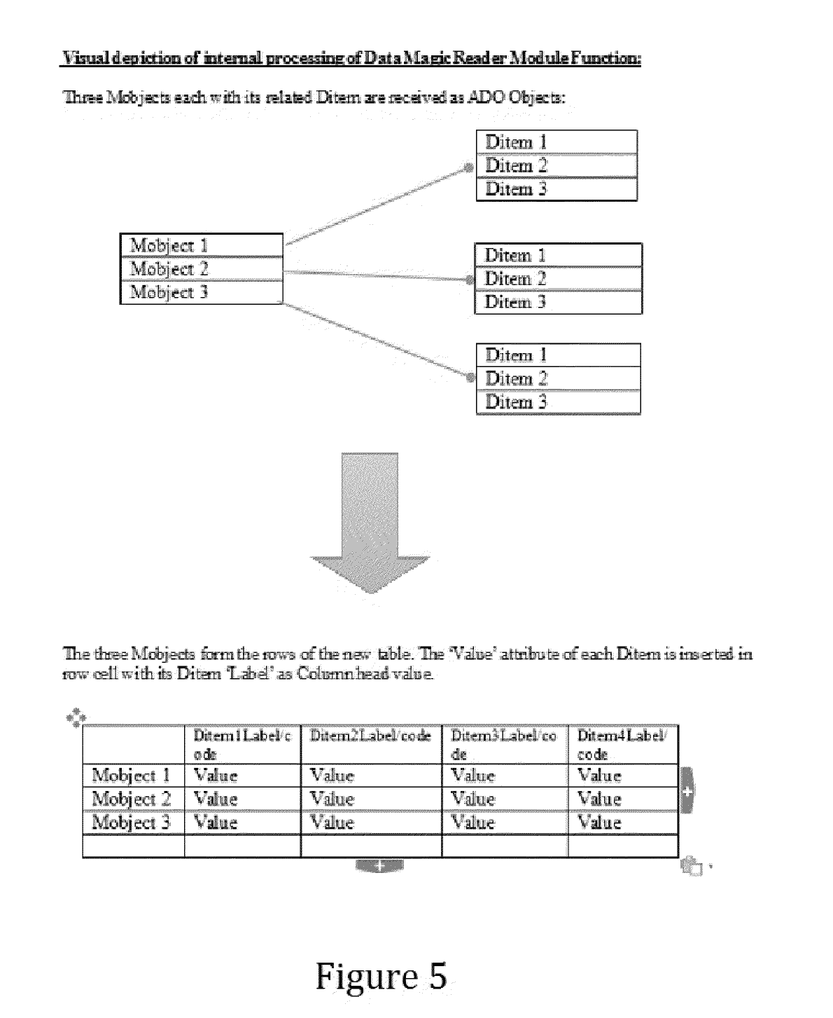

FIG. 5 shows a visual depiction of internal processing of Data Magic Reader Module Function.

The Central Application (CA)

The central application is the component software that puts all the previous modules to operate together in order to execute the basic functions (i.e. Business domain data capture, storage, and retrieval as information relevant to the domain and according to its needs).

The Central application enables the user to browse the ready templates created by Template Builder. The user can fill data in the retrieved template, gets it strongly typed by relevant real-time variables, and then saves in the Production Database. Later, the user can retrieve this data either formatted in the same forms as it was entered, or use a set of prepared and ready-made reports or queries.

The functions—Inputs/Outputs—of the central application are:

a) Retrieve, process, and generates real time dynamic variables that are related to the basic functions of the application such as loading identifiers, loading authentication variables values, application Data Service Keys, config. Files information, etc.

b) Manage the application settings, config files, and cached information.

c) Display/browse and search lists of available XML templates

d) Process retrieved XML files to display either a web form or process a web report.

In case of web forms:

e) Captures domain user input in web forms generated from the loaded ASPX files.

f) Adds to the user input dynamic real time data that strongly types the web forms (Mobjects) by adding identifying attributes values related to the domain object being processed. This will, for example, include the name of a person, his national identifier, or a specific GUID.

g) Processes user input to generate XML files updated with the captured data items values related to domain object.

h) Submits the now data-loaded XML files to the SBMTR module for insertion in the Production database.

i) Permits user to perform search operations on the Production Database.

In case of web reports:

j) Passes on the web report XML Mobject to the Data Module Application to extract the codes of Mobjects/Ditems that need to be retrieved according to the filter criteria precised in the XML body of the Mobject/Ditem.

k) Receives returned XML files from Reader module in response to the sent XML Mobjects/Ditems.

l) Process returned files to display it for user review as a friendly text after removing XML mark-up.

m) Responds to users requests to edit retrieved files (if the returned Mobject's attributes permit that) by retrieving the original template using Mobject's ‘TemplateId’ attribute—from the ASPX templates database—to display the form in its original form and combining it with the retrieved Production database data to display it to the user for any further edit.

n) Permits printing of reports.

ASPXTemplate Database

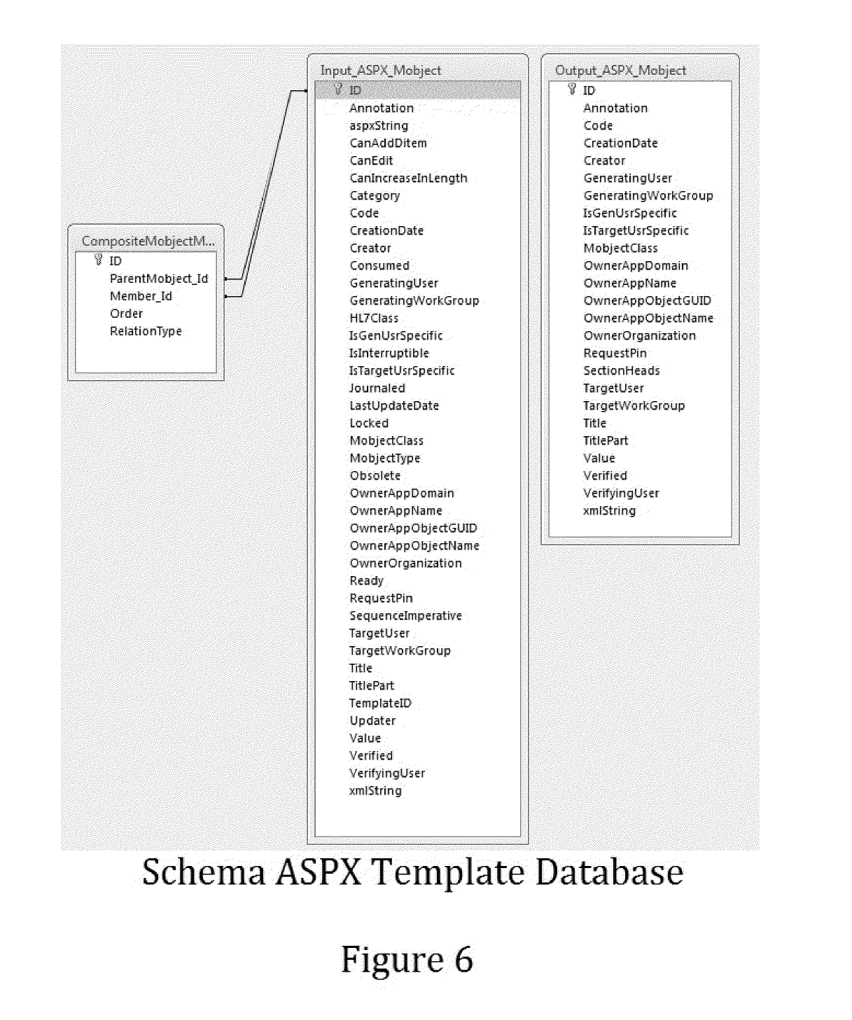

The ASPXTemplateDatabase hosts all the ASPX templates of web-forms, web-reports, and queries. FIG. 6 shows a Schema of the ASPX Template Database. The ‘Category’ attribute of any template should determine whether it is a web form (Input Mobject) or a web report (Output Mobject), or a query. Each type of mobject is stored in a special table. The XMLTemplate Database exposes its contents as lists to users of the Central Application so that they can retrieve the template they need for their business transactions.

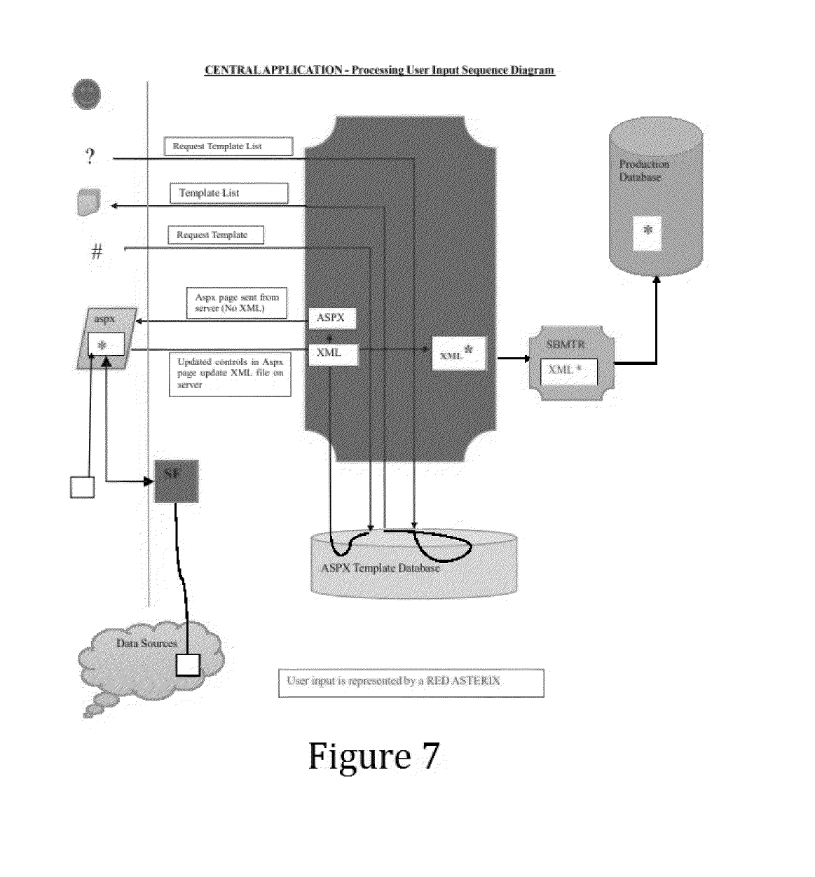

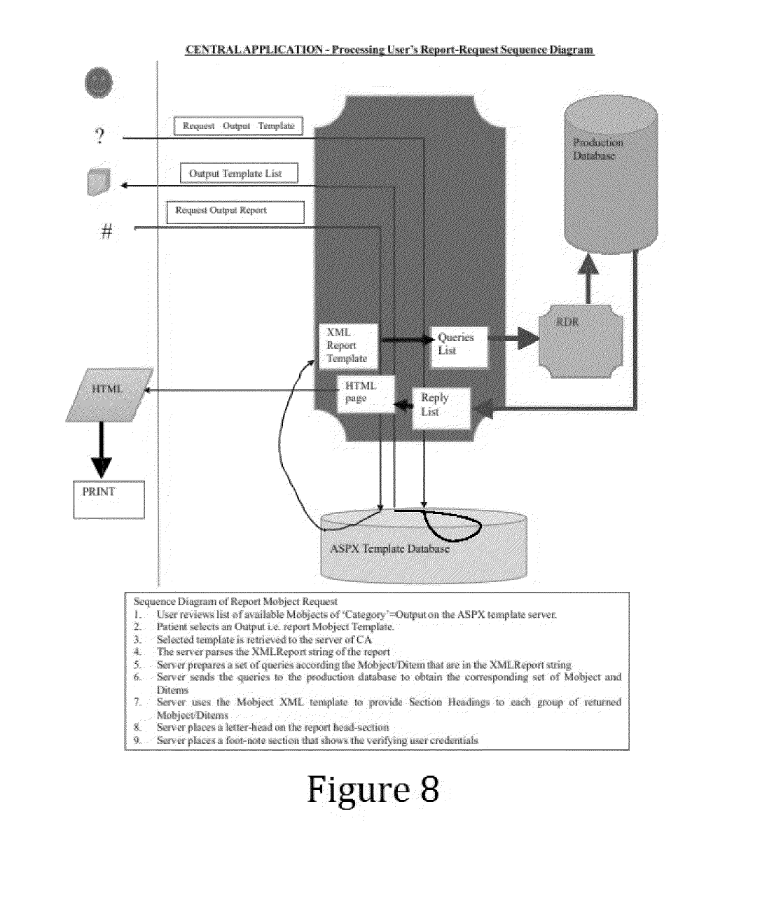

FIG. 7 displays the central application—Processing User Input Sequence Diagram and FIG. 8 displays the central application—Processing User's Report-Request Sequence.

The Selector Form Module (SF)

User data input in web forms of the current invention comes from three sources:

1. Free user data input; and

2. Data input returned by the Selector Form.

3. System provided run-time values

In order to ensure that all users of the business domain are using the same standardized values to fill in the web controls, a standardized method of fetching data has been particularly developed for the current invention.

SF is a server module that provides dynamic-real time data querying, display, and selection services from any enabled data source of any type and any location (intranet, internet). By using the Selector Form, Text boxes and Combo boxes displayed on web forms are directed to retrieve their feeding information from the particular data source pre-determined by the creator of the Ditem.

### Example 1

To select a bank account to populate a text box, the Selector Form is tied to the Ditem representing this particular text box, which is also pointed towards the data source that holds the list of valid bank accounts to populate this text box.

### Example 2

If a surgeon wants to enter the name of a anatomical structure in the current invention web form control. The name of this structure could vary between two surgeons even working in the same place. Selector Form plays a standardizing role by being pre-set by the web control creator to access a pre-designated data source to provide consistent naming for all anatomical structure in the domain.

The rational for using the SF is that it restricts, where needed, the values accepted by the current invention application to the sources of data designated by domain power users who created the web controls i.e. the Ditems. Standardization and uniformity of naming of different Ditems, and providing consistent values to the named Ditems ensure that searches performed on the Production Database are always done with very little chances of missing certain names/values that have been otherwise named differently.

The system 1 is set to run a on a computing device 11. A computing device on which the present invention can run would be comprised of a CPU, Hard Disk Drive, Keyboard, Monitor, CPU Main Memory and a portion of main memory where the system resides and executes. A printer can also be included. Any general purpose computer with an appropriate amount of storage space is suitable for this purpose. Computer Devices like this are well known in the art and are not pertinent to the invention. The system can also be written in a number of different languages and run on a number of different operating systems and platforms. The system is network based and works on an Internet, Intranet and/or Wireless network basis as well as a stand alone system.

As shown in FIG. 9, the users 10 would access the system 1 through a network 100 or Internet 500. The system's software would reside in the system's memory 310. There are a number of different components of the system 1, these are described below.

The system 1 uses a memory means such as a standard hard drive or any other standard data storage device to store the data.

As to a further discussion of the manner of usage and operation of the present invention, the same should be apparent from the above description. Accordingly, no further discussion relating to the manner of usage and operation will be provided.

It should be appreciated that many other similar configurations are within the abilities of one skilled in the art and all of these configurations could be used with the method of the present invention. Furthermore, it should be recognized that the computer system and network disclosed herein can be programmed and configured by one skilled in the art in a variety of different manners to implement the method steps described further herein.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A data capture, storage, and retrieval software system comprising the steps: running on a computer device having two programmatic objects Mobjects and Ditems.

2. The system as defined in claim 1, wherein said Ditem represents a reports's field, where a ‘Value’ of the Ditem represents the content of the web control, and a ‘Label’ of the Ditem represents that control's label.

3. The system as defined in claim 1, wherein said Mobject holds also all metadata that relates to a GUI in which the Mobject will be ultimately displayed to users and where the Mobject represents a form itself, and the Mobject's ‘Value’ is Title of that form or web page.
